(19) United States
(12) Patent Application Publication
(10) Pub. No.: US 2026/0264591 A1
(43) Pub. Date: Sep. 10, 2026

(54) MOTOR VEHICLE SEAT PADDING

(71) Applicant: TESCA PACIFIC, Cedex (FR)

(72) Inventors: Sergio PERIANES, Cedex (FR); Angel Suana GENICIO, Cedex (FR)

(21) Appl. No.: 19/120,236

(22) PCT Filed: Oct. 10, 2023
(86) PCT No.: PCT/EP2023/078083

§ 371 Date: Jun. 17, 2025

(30) Foreign Application Priority Data
Oct. 11, 2022 (FR) FR2210437

(51) Int. Cl. B60N 2/64

(52) U.S. Cl. CPC B60N 2/64

(57) ABSTRACT

The invention relates to padding (1) for a motor vehicle seat, the padding comprising a knitted textile cover (10), the cover being provided with at least one additional stitching (13) of anchoring loops (14) derived from the knitting of the cover, the anchoring loops intersecting with the structural loops (11) by additional crossing points (15) connecting them together, an anchoring loop (14) extending between two additional crossing points (15), the additional stitching extending opposite a fastening element (4) so that the hooks (7) of the element are anchored in the additional loops.

The invention concerns a padding for a motor vehicle seat and a motor vehicle seat comprising such a padding.

It is known to produce a padding for a motor vehicle seat, said padding comprising:
a padding block presenting a face for receiving an occupant of said seat,
a knitted textile cover covering said receiving face, said cover having a stitching made up of a plurality of structural loops intersecting at structural crossing points connecting them together,
at least one element for fastening said cover to said block, said element being formed by a flexible support layer provided on a first face with a plurality of hooks projecting from said face, said element being fastened, by a second face opposite said first face, to said receiving face.

To ensure fastening of the cover to the padding block, it is known to associate, on the reverse side of the cover, a reciprocal fastening element made up of fibres that form loops for the hooks to anchor into.

However, such an embodiment requires the reciprocal fastening element to be associated on the reverse side of the cover, for example by gluing or sewing, which complicates the manufacturing of the padding.

The aim of the invention is to overcome this drawback.

To this end, and according to a first aspect, the invention proposes a padding for a motor vehicle seat, said padding comprising:
a padding block presenting a face for receiving an occupant of said seat,
a knitted textile cover covering said receiving face, said cover having a stitching made up of a plurality of structural loops intersecting at structural crossing points connecting them together,
at least one element for fastening said cover to said block, said element being formed by a flexible support layer provided on a first face with a plurality of hooks projecting from said face, said element being fastened, by a second face opposite said first face, to said receiving face,
   said padding also having the following features:
said cover is further provided with at least one additional stitching of anchoring loops derived from the knitting of said cover, said anchoring loops intersecting with said structural loops by additional crossing points connecting them together, an anchoring loop extending between two additional crossing points,
said additional stitching extends opposite said fastening element so that said hooks are anchored in said additional loops.

With such an arrangement, the cover is attached directly to the fastening element without the addition of a reciprocal fastening element attached to the reverse side of said cover, the additional stitching forming a reciprocal fastening means integrated into the cover.

The result is a simplified manufacturing of the padding.

According to a second aspect, the invention proposes a motor vehicle seat comprising such a padding.

Further features and advantages of the invention will become apparent from the following description, made with reference to the attached figures, in which:

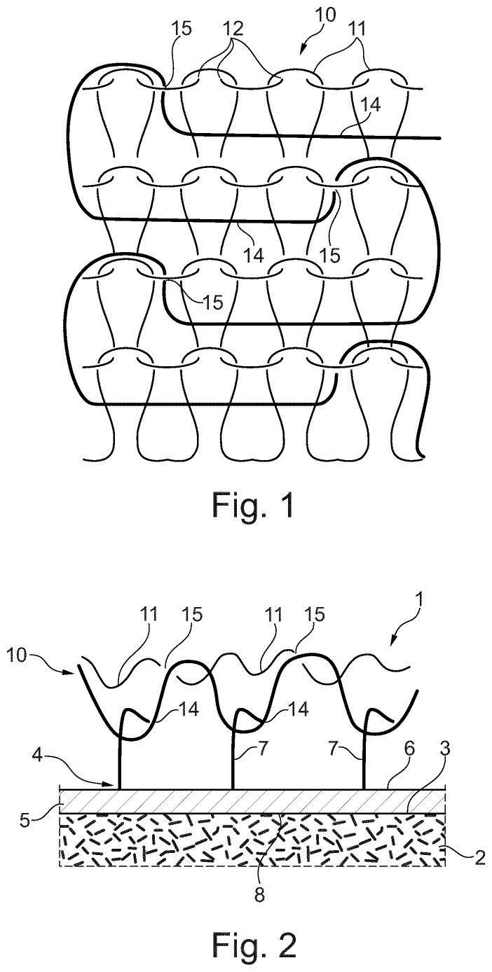

FIG. 1 is a schematic partial front view of the reverse side of a cover according to one embodiment,

FIG. 2 is a schematic partial cross-sectional view of a padding provided with the cover shown in FIG. 1,

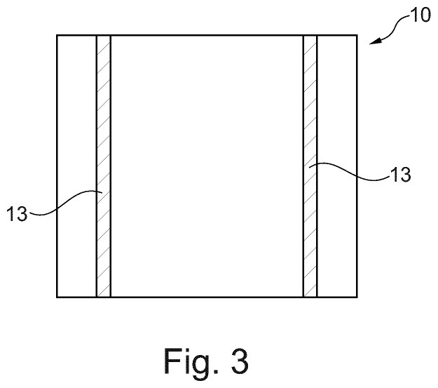

FIG. 3 is an overall schematic front view of the reverse side of the cover shown in FIG. 1, according to one embodiment.

With reference to the figures, a padding 1 for a motor vehicle seat is described, said padding comprising:
a padding block 2 presenting a face 3 for receiving an occupant of said seat,
a knitted textile cover (10) covering said receiving face, said cover having a stitching made up of a plurality of structural loops (11) intersecting at structural crossing points (12) connecting them together,
at least one element 4 for fastening said cover to said block, said element being formed by a flexible support layer 5 provided on a first face 6 with a plurality of hooks 7—in particular of the Velcro type—projecting from said face, said element being secured, by a second face 8 opposite said first face, to said receiving face,
   said padding also having the following features:
said cover is further provided with at least one additional stitching 13 of anchoring loops 14 derived from the knitting of said cover, said anchoring loops intersecting with said structural loops by additional crossing points 15 connecting them together, an anchoring loop 14 extending between two additional crossing points 15,
said additional stitching extends opposite said fastening element so that said hooks are anchored in said additional loops.

According to the embodiment shown, the developed length of an anchoring loop 14 is greater than the developed length of structural loop wire 11 between two successive structural crossing points 12, so that said anchoring loop has a developed length sufficient to receive one or more hooks 7.

According to the embodiment shown, an anchoring loop 14 extends opposite a plurality of structural loops 11.

In one embodiment, partially illustrated in FIG. 3, the padding 1 comprises a plurality of fastening elements 4, each of which cooperating with a respective additional stitching 13.

In particular, a fastening element 4 and the corresponding additional stitching 13 are in the form of a strip, so as to ensure substantially linear fastening of the cover 10 to the block 2.

According to a further, not shown embodiment, a fastening element 4 and the corresponding additional stitching 13 are in the form of a medallion with a maximum dimension of less than 50 mm, so as to ensure substantially punctual fastening of the cover 10 to the block 2.

In one embodiment, the fastening element 4 is attached to the block 2 by adhesive bonding.

In another embodiment, the block 2 is based on molded foam—in particular polyurethane—and the fastening element 4 is attached to said block by overmolding.

In one embodiment, the support layer 5 has a thickness of less than 1 mm, so as not to generate any noticeable extra thickness between the block 2 and the cover 10, in order to optimize the comfort and appearance of the padding 1.

Finally, in a not shown manner, we describe a motor vehicle seat comprising a metal frame, a suspension web associated with said frame and a padding 1 as described above, said padding being mounted on said web.

1. Padding (1) for a motor vehicle seat, said padding comprising:
a padding block (2) having a face (3) for receiving an occupant of said seat,
a knitted textile cover (10) covering said receiving face, said cover having a stitching made up of a plurality of structural loops (11) intersecting by structural crossing points (12) connecting them together,
at least one element (4) for fastening said cover to said block, said element being formed by a flexible support layer (5) provided on a first face (6) with a plurality of hooks (7) projecting from said face, said element being secured, by a second face (8) opposite said first face, to said receiving face,
said padding being characterized in that:
said cover is further provided with at least one additional stitching (13) of anchoring loops (14) derived from the knitting of said cover, said anchoring loops intersecting with said structural loops by additional crossing points (15) connecting them together, an anchoring loop (14) extending between two additional crossing points (15),
said additional stitching extends opposite said fastening element so that said hooks are anchored in said additional loops.

2. Padding according to claim 1, characterized in that the developed length of an anchoring loop (14) is greater than the developed length of structural loop wire (11) between two successive structural crossing points (12), so that said anchoring loop has a developed length sufficient to receive one or more hooks (7).

3. Padding according to claim 2, characterized in that an anchoring loop (14) extends opposite a plurality of structural loops (11).

4. Padding according to claim 1, characterized in that it comprises a plurality of fastening elements (4) each cooperating with a respective additional stitching (13).

5. Padding according to claim 1, characterized in that a fastening element (4) and the corresponding additional stitching

(13) are in the form of a strip, so as to ensure substantially linear fastening of the cover (10) to the block (2).

6. Padding according to claim 1, characterized in that a fastening element (4) and the corresponding additional stitching (13) are in the form of a medallion with a maximum dimension of less than 50 mm, so as to ensure substantially punctual fastening of the cover (10) to the block (2).

7. Padding according to claim 1, characterized in that the fastening element is attached to the block (2) by adhesive bonding.

8. Padding according to claim 1, characterized in that the block (2) is based on molded foam, the fastening element (4) being attached to said block by overmolding.

9. Padding according to claim 1, characterized in that the support layer (5) has a thickness of less than 1 mm.

10. Motor vehicle seat comprising a metal frame, a suspension web associated with said frame and a padding (1) according to claim 1, said padding being mounted on said web
